(19) United States
(12) Patent Application Publication
(10) Pub. No.: US 2009/0037281 A1
(43) Pub. Date: Feb. 5, 2009

(54) System and method of providing purchase receipts

(76) Inventors: Edward A. Devlin, Downingtown, PA (US); Monal Patel, Wilmington, DE (US)

Correspondence Address: DUAN MORRIS LLP, Suite 1000, 505 9th Street, N.W., Washington, DC, 20004, US

(21) Appl. No.: 12/219,812

(22) Filed: Jul. 29, 2008

Related U.S. Application Data
(63) Continuation-in-part of application No. 10/661,886, filed on Sep. 15, 2003.
Application No. 10/661,886 is a continuation of application No. 09/495,819, filed on Feb. 2, 2000, now Pat. No. 6,748,365.
Application No. 09/495,819 is a continuation-in-part of application No. 10/098,948, filed on Mar. 15, 2002.
(60) Provisional application No. 60/154,087, filed on Sep. 15, 1999.

(51) Int. Cl. G06Q 30/00; G06Q 20/00; G07G 1/00

(52) U.S. Cl. 705/14; 705/24; 705/16

(57) ABSTRACT

A system and method for providing a purchaser a purchase transaction receipt having a reduced set of information including a transaction identification number, where the transaction identification number can be used by the purchaser to access rebate information and the purchase transaction related information.

The present application is a continuation in part of U.S. patent application Ser. No. 10/661,886 filed Sep. 15, 2003, which is a continuation of U.S. Pat. No. 6,748,365 filed Feb. 2, 2000, which claims the priority of U.S. Provisional Patent App. No. 60/154,087 filed Sep. 15, 1999. The present application is also a continuation in part of U.S. patent application Ser. No. 10/098,948 filed Mar. 15, 2002, which is a continuation in part of U.S. Pat. No. 6,748,365 filed Feb. 2, 2000, which claims the priority of U.S. Provisional Patent App. No. 60/154,087 filed Sep. 15, 1999. The disclosure of the above referenced patents and patent applications are all incorporated by reference herein.

The present disclosure is directed to a system and method of providing purchase receipts. More specifically the present disclosure includes a novel system and method of redeeming rebates where a traditional receipt is not issued at the point of sale.

### BACKGROUND

Retailers and manufacturers have used a variety of methods for promoting the sale of their goods and services. For example, coupons are a well known device for encouraging the consumer to purchase goods and/or services by providing a discount at the point of sale upon presentation by the customer of the coupon. Coupons have traditionally been delivered to potential customers by using direct mail, in publications, or in advertising circulars delivered independently or in conjunction with newspapers. The coupons present an instant discount at the point of sale, but require prior planning by the customer to ensure the coupon is in their possession at the time that the customer purchases the products.

Another well known method used by retailers and manufacturer is implementation of a loyalty program. Typically a customer pre-registers for a program by providing name, address and perhaps by answering a short survey with respect to their preferences, and is issued a loyalty card to be presented when they purchase products or services. The loyalty card provides a mechanism for retailers and manufacturers to track the purchasing patterns of the customers, and can provide the customer with an immediate discount at the point of sale, or can be used to track purchases to allow the customer to accrue credits to be used for some future purchase. Loyalty programs are well known in the airline industry as frequent flyer programs, and are well known in the grocery industry as loyal customer rewards or discount programs.

Rebates are another well known technique used by retailers and manufacturers to promote the sale of their goods and services. However, unlike the coupon programs and loyalty programs discussed above, rebate programs require that the customer take some action subsequent to the purchase of the goods and/or services in order to redeem the rebate. However, the mechanics of providing a rebate for purchased goods and services provides and opportunity for unscrupulous consumers to fraudulently request rebates for goods and services that were not actually purchased. Because a rebate does not provide a credit or price reduction at the point of sale, the retailers and manufacturers must implement a method of validating that an actual sale of the rebated product or service took place prior to providing the rebate. For example, one typical way to validate a rebate is to require that the consumer to remove and provide the Universal Product Code (UPC) or some other product specific code from the packaging of a product to the rebate fulfillment processor along with a copy of the purchase receipt in order to allow the rebate fulfiller to validate that an actual purchase of the sale took place. Coupon and loyalty programs do not suffer from such requirements since the credit is normally given at the point of sale or shortly thereafter without further information being required from the customer. However, a rebate program requires that the consumer take some affirmative action after the sale in order to qualify for the rebate.

In the typical rebate scenario, the customer is provided with a receipt of the purchased products which includes an identification of the specific product and the price paid for the product. This receipt along with other information is provided by the consumer to a rebate fulfillment center in order to redeem the rebate.

The above reference patents and applications describe an improved method of submitting and validating rebates by issuing the customer a unique transaction number at the point of sale of the goods and/or services. The unique transaction number could then be provided by the customer with a rebate request. The use of a transaction number greatly simplifies the rebate redemption process since the customer is no longer required to remove and provided UPC codes, or provide the purchase transaction receipt in order to provide that the purchase of the rebated product occurred.

It is very common for retailers to provide a purchase receipt at the point of sale for the goods and services being purchased. Some retailers provide a purchase transaction receipt, as well as a rebate receipt, having information specifically for redeeming a rebate for a purchased product. In addition, some retailers produce a print out of coupons simultaneously or in conjunction with providing their consumers a purchase transaction receipt. A purchase transaction receipt is beneficial as it gives the seller an opportunity to document a purchase transaction for use later to track and authorize subsequent returns, refunds and rebates, as well as other methods for validating that the purchase of a good or service actually occurred. Information that has typically been provided on prior art purchase receipts include, individual product identification, gift receipts, warranty and return information, rebate receipts and forms, coupons, loyalty points, surveys, sweepstakes and other marketing promotions. For purchases from on-line retailers, in addition to the information identified above which may be provided at the time a product is shipped, the retailer may also provided packing slips or other delivery related information. In addition to the purchase receipt information discussed above, the retailer may also provide instruction and user manuals, product use information, terms and conditions, safety information, licenses, labeling and contents information, regulatory requirements.

The delivery of a purchase transaction receipt by the retailer at the point of sale requires the retailer to incur certain costs in providing the purchase transaction receipt, and such cost can be increased if the retailer also provides a rebate receipt and is further increased if the retailer provides coupons at point of sale as well.

The present disclosure is directed to reducing the amount of hardcopy receipts and other paper that a retailer generates at the point of sale.

### BRIEF DESCRIPTION OF THE DRAWINGS

FIG. 1 is a simplified flow diagram of one embodiment of the present disclosure.

FIG. 2 is a simplified pictorial illustration of one embodiment of a reduced information receipt described in the present disclosure.

### DETAILED DESCRIPTION

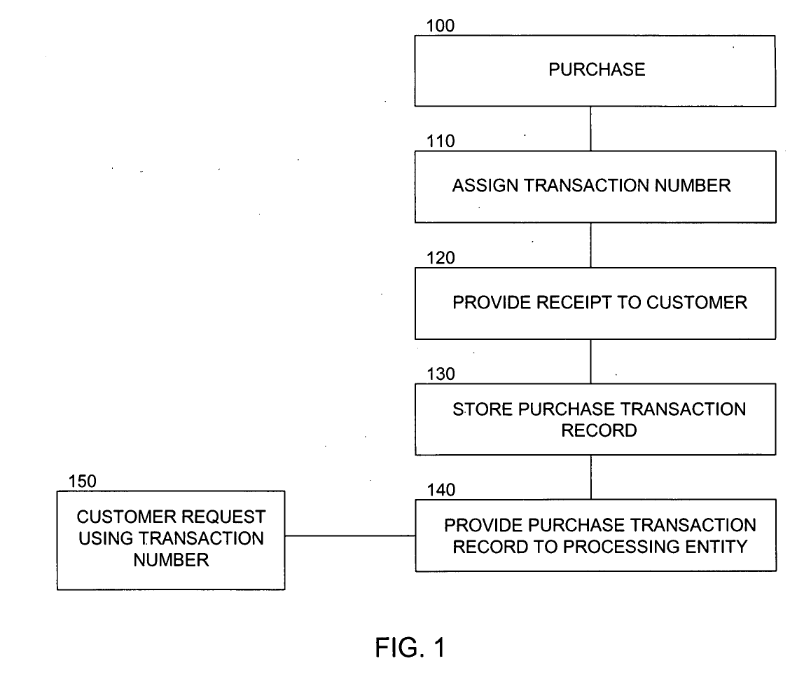

FIG. 1 illustrates one embodiment of the present disclosure. A customer purchases 100 a product or service from a marketing entity. The purchase transaction can be a standard transaction at a checkout register with the purchaser making a payment for the purchased products or services using cash, check, any credit cards (incl. store credit cards), debit cards, gift cards, store credits, etc.

At the time of the purchase, the marketing entity assigns a unique transaction number to the purchase transaction 110. The marketing entity provides a purchase transaction receipt to the customer. In one embodiment the customer is given a receipt that includes a reduced amount of information than is normally provided following a purchase transaction 120. In one embodiment, the receipt includes a transaction number which uniquely identifies the purchase transaction, and instruction on how to access the product specific information and other information that would other wise have been provided to the customer with a conventional receipt. In one embodiment, the instructions identify a website which the purchaser can visit and use the provided transaction number to access the purchase receipt information. Thus, although the purchaser is receiving a reduced information receipt from the POS, the information provided allows the purchaser to gain access at a later time, to more detailed information, including specific products and prices, regarding the purchase transaction.

All purchases made by customers may be stored by the retailer 130. The method of storage may vary by the retailer. The retailer may transmit the purchase transactions to an in-store database or retailer database or directly to third party support provider or processing entity. Data may be transmitted to all databases as well at the same time or in some sequence. This data transferred to the third party support provider may be via one or more available methods like File transfer, Web Service and others.

In one embodiment, the purchase transaction information is transmitted to a third party support provider 140. The third party support provider may be a computing environment that consists of web servers, database servers, administrative servers, FTP servers, e-mail servers, networking equipment, powering equipment running software that interacts with the internal/external hardware, customer inputs, retailer, merchants, vendors, health information providers, internal officers, etc.

In one embodiment, customer can access their purchase transaction information by connecting to the third party support provider through any suitable communications means, such as, telephone network, public switch telephone network, intranet, Internet, extranet, WAN, LAN, point of interaction device (like PDA, cellular phone, etc.), wireless communication, satellite communication, etc. 150. During their initial communication with the third party support provider, the customer may be asked to create an account, which may request the customer to provide identifying information, contact information, preferences, etc. The customer may be required to create a username and password for controlling future access to the account. If the retailer has provided purchase transaction information to the third party support provider, the customer may be able to access the information. In one embodiment, the retailer may provide all transaction to the third party support provider on a periodic basis. In another embodiment, the third party support provider may request that specific transaction, e.g., based on transaction number, be transmitted to the third party support provider.

The information stored from the purchase transactions can be accessed by the customer in a variety of methods 150. In one embodiment, the customer may make an electronic request using the provided transaction number to a third party support provider. The third party support provider can use the transaction number supplied by the customer to match with a transaction number provided by the retailer. In response to a match, the third party support provider can provide the customer with the purchase transaction information received from the retailer. For example, the purchaser can use a web browser to supply the purchase transaction identifier, and in response the third party provider requests the retailer's on-demand/web service and extracts the related information for that transaction and displays it to the purchaser. In one embodiment, the customer may be provided with an electronic copy of a page containing the information which would typically be provided on a typical purchase transaction receipt, including identification of the products, product codes, prices, etc. This information may include individual product identification, gift receipts, warranty and return information, rebate receipts and forms, coupons, loyalty points, surveys, sweepstakes and other marketing promotions. This information may be displayed on the customer's computer monitor and be printed out as the customer desires. The customer can download this information for personal software applications, including personal financial and tax preparation software or print this copy of the receipt for their records for Flexible Spending Account, Health Saving Account. In addition to providing information related to the purchase transaction, at the same time, the customer may be provided with additional information including, the customer may also be asked to participate in a survey or register for sweepstakes, print rebate receipt and forms or submit for rebates, check their reward points/loyalty points, or redeem their loyalty points for an reward. The customer may also be provided with additional offers, including coupons for new purchase/savings, coupons from same merchant/vendor or a competitor, coupons for a meal deal, or for a combination purchase like Music CDs and headphone or HD-DVD player and HD-DVDs. The customer may also be provided with a personalized shopping list for next shopping trip based on the information stored regarding previous purchase transactions.

The disclosures of the present application can be implemented using conventional computer processing and memory systems capable of reading software applications on computer readable medium for performing the disclosed steps and functions.

Use of reduced information receipts has many advantages. It is common to see discarded receipts in the areas surrounding issuance of the receipts, particularly in the areas surrounding retail stores. To a certain extent some customers do not desire to receive receipts and thus the litter associated with discarded receipts can be expected to be less for smaller receipts. Thus the disclosed reduced information receipts may provide an environmentally-friendly solution to providing transactions receipts.

The disclosed receipts also provide an opportunity for the retailer to reduce the costs associated with providing the receipts.

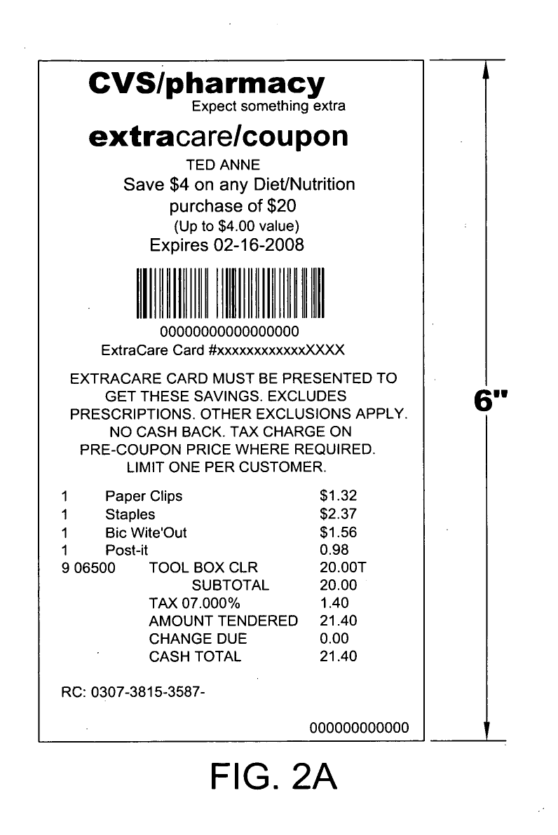

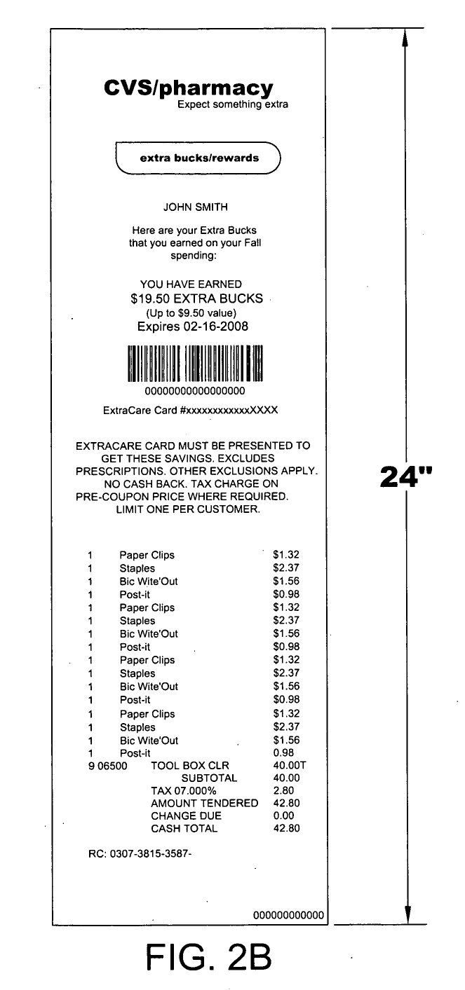

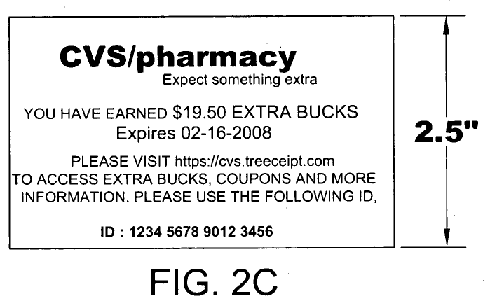

With reference to FIG. 2, the savings that can be realized with one embodiment of the present disclosure is illustrated. FIGS. 2A and 2B are illustrations of prior art receipts utilized by retailers. FIG. 2A is a retail receipt which includes a listing of each product purchased the cost of each item, the total costs of the products sold. The retail receipt is printed out at the point of sale by the retailer and provided to the purchaser. FIG. 2B illustrates a rebate receipt which is another type of receipt that is commonly used with retailers and provided to a purchaser in addition to receipt of FIG. 2A. The rebate receipt is typically printed out when one of the products purchased on the retail receipt has a rebate offer associated with it. The rebate receipt includes information specific to the rebate such as the terms and conditions of the rebate, amount of rebate and an area for the purchaser to fill in purchaser specific identifying information. In this example, the retail receipt of FIG. 2A is six inches long, and the rebate receipt of FIG. 2B is twenty-four inches long so that for a single purchase transaction, the purchaser is provided with a total of thirty inches of receipt paper.

FIG. 2C illustrates a reduced information receipt according to the teachings of the present disclosure. The reduced information receipt is produced at the POS by the retailer, and does not include an identification of the products, the costs of the products and the total as is included on the retail receipt of FIG. 2A. The reduced information receipt of FIG. 2C only includes transaction number and a limited set of instructions for the rebate redemption and purchasing information retrieval. In the present embodiment, the reduced information receipt of FIG. 2C is only 2.5 inches long, (a 92% reduction in the paper used for the receipts of FIGS. 2A and 2B.) The transaction identifier which is supplied by the retailer at the point of sale may be used by the purchaser, at purchaser's option, to retrieve information related to the purchase transaction and perform other actions. For example a purchaser may use the transaction identifier to received an electronic copy of a purchase receipt having information similar to that provided by the receipt n FIG. 2A. Likewise the purchaser can use the transaction number to submit a request for a rebate using the system and methods disclosed in the above referenced patents and applications.

Thus, the receipt of FIG. 2C conveys sufficient information for the purchaser to access the information provided by prior art receipts 2A and 2B, but at a greatly reduced amount of paper being used. The reduction in the amount of paper can provide significant financial benefits to the retailer. For example, if the retailer saves 10 for each inch of paper not used in a receipt, and the retailer averages 6 million rebate transactions per year using the receipts illustrated in FIGS. 2A and 2B, the retailer would save approximately $1.65 million by using the embodiment disclosed in FIG. 2C instead.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed:

1. A method of providing a reduced information customer receipt for the purchase of a product or service during a purchase transaction, comprising the steps of:
(a) assigning at the point-of-sale of a purchase transaction, a unique transaction identifier for the transaction;
(b) providing at the point of sale a purchase receipt to a purchaser, the purchase receipt including the unique transaction identifier but not containing an identification of the purchased goods or services; and
(c) storing as a data record, the unique transaction identifier and an identification of the purchased goods or services associated with the unique transaction for subsequent access to the purchaser.

2. The method of claim 1 further comprising the step of
(d) displaying the identification of the purchased goods or services to the purchaser in response to a request from the purchaser made subsequent to the purchase transaction.

3. The method of claim 2 wherein the request from the purchaser includes an electronic request including the transaction identifier.

4. The method of claim 1, further comprising the step of
(d) providing at least a portion of the stored data record to a processing entity for subsequent access of the stored data to the purchaser.

5. The method of claim 2 wherein the step of displaying includes transmitting the identification of the purchased goods and services for display on a display screen.

6. The method of claim 4, wherein the step of providing at least a portion of the data record is done is response to a request from a marketing entity.

7. A method of providing purchase information for a purchase transaction in which a purchaser has purchased one or more products or services, comprising the steps of:
(a) receiving at a processing site from a marketing entity the identification of at least a portion of the products or services purchased in a purchase transaction, and a unique transaction identifier, such identifier being assigned at the point-of-sale of a purchase transaction;
(b) receiving at the processing site from the purchaser subsequent to the completion of the purchase transaction, a unique transaction identifier associated with a purchase transaction;
(c) using at the processing site, the unique transaction identifier provided by the purchaser to access the information provided by the marketing entity to ascertain the identification of the products and services associated with the transaction identifier provided by the purchaser;
(d) providing to the purchaser information related to the identified products or services as a function of the identified products and services.

8. The method of claim 7, wherein the step of providing to the purchaser includes the step of selecting at least one of a rebate, coupon, reward survey, account status, contest and warranty information associated with one of the identified goods or services and providing the selected information to the purchaser.

9. The method of claim 7 wherein the step of providing includes transmitting the identification of the purchased goods and services for display on a computer monitor.

10. The method of claim 7 further comprising the steps of:
(e) receiving at the processing site, information relating to a promotion associated with the purchased product or service;
(f) providing the promotion information to the purchaser.

11. The method of claim 10 wherein the promotion is a coupon.

12. The method of claim 10 wherein the promotion is a rebate.

13. The method of claim 10 wherein the promotion is a sweepstakes entry.

14. The method of claim 10 wherein the promotion is a credit voucher.

15. The method of claim 10 wherein the promotion is a reward.

16. The method of claim 7, wherein step (b) the transaction identifier received from the purchaser is received over a communication network.

17. The method of claim 16, wherein the communication network is one of a telephone network, intranet, Internet, extranet, WAN, LAN, and wireless network.

18. The method of claim 9, wherein the identification of the purchased goods and services are transmitted over a communication network.

19. The method of claim 18, wherein the communication network is one of a telephone network, intranet, Internet, extranet, WAN, LAN, and wireless network. Add security and privacy loyalty.

20. A computerized system for providing purchase transaction information to a purchaser who, during a sales transaction, had purchased one or more products or services, and in which such purchaser had been given a transaction identifier for identifying such transaction but has not been provided with a receipt identifying the purchase products or services at the point of sale; said system comprising:
at least one data input port for receiving:
(a) a plurality of purchase data records, each purchase data record pertaining to a sales transaction, wherein each purchase data record
(i) includes a transaction code for identifying the sales transaction and (ii) identifies the products or services purchased in connection with such transaction; and
(b) a purchaser request containing a transaction code assigned at the point of sale;
a memory communicating with said at least one data input port for storing as a stored data record each transaction code and the identity of all products or services associated with such transaction code;
a processor communicating with said at least one data input port and said memory and which is programmed, in response to receiving a purchaser request:
(i) to seek to match the transaction code submitted in the purchaser request with a transaction code of a stored data record; and
(ii) upon successfully matching a transaction code submitted with a purchaser request with a transaction code stored in a stored data record, to provide the identification of the products and services associated with the matched transaction code to the purchaser.

21. The computerized system of claim 20, further comprising a display for displaying the identified products or services.

22. The computerized system of claim 20 wherein:
the at least first data port is further for receiving:
(iii) information related to promotions for the purchased goods or services;
the memory is further for storing the information related to the promotions; and
the processor is further programmed for identifying promotions for the purchased products and services associated with the matched transaction code.

23. A system as defined in claim 22, wherein said promotion is one of a coupon, rebate, reward, sweepstakes entry and credit voucher.

24. A system as defined in claim 22, wherein the information provided to the customer is provided in electronic format.

25. A system as defined in claim 24, wherein the electronic format is compatible with a purchaser software application.

26. A system defined in claim 25 wherein the software application is one of personal financial software application, benefits software application, viewer application.
